(19) United States
(12) Patent Application Publication
(10) Pub. No.: US 2003/0067625 A1
(43) Pub. Date: Apr. 10, 2003

(54) System for printing specific part of printing data stored in printer and method for controlling the same

(75) Inventor: Chan-Hoo Kim, Seoul (KR)

Correspondence Address: STAAS & HALSEY LLP, 700 11TH STREET, NW, SUITE 500, WASHINGTON, DC, 20001, US

(73) Assignee: SAMSUNG ELECTRONICS CO., LTD, Suwon-city (KR)

(21) Appl. No.: 10/152,586

(22) Filed: May 23, 2002

(30) Foreign Application Priority Data
Oct. 4, 2001 (KR) 2001-61249

(51) Int. Cl. G06F 15/00; G06F 3/12; G06F 13/00; G06K 15/02

(52) U.S. Cl. 358/1.15; 358/1.16

(57) ABSTRACT

A printing system to print a selected portion of printing data stored in a printer. The printing system includes a printer to print the printing data stored in an internal memory device onto sheets of printing paper according to a print command externally transmitted, and a printer control device to set the portion of the stored printing data. The printer control device transmits a print command to the printer with respect to the portion of the stored printing data when a user selects the portion of the printing data and inputs a corresponding print command. The printer provides the printer controller with information about the stored printing data. The printer controller displays the information provided by the printer. A print request signal for the selected portion of the printing data is transmitted to the printer. Then the printer performs a printing operation according to the print command. The user is able to print the desired portion of the stored printing data, and accordingly, unnecessary printing and waste of resources are prevented.

### CROSS-REFERENCE TO RELATED APPLICATIONS

This application claims the benefit of Korean Application No. 2001-61249, filed Oct. 4, 2001, in the Korean Industrial Property Office, the disclosure of which is incorporated herein by reference.

### BACKGROUND OF THE INVENTION

1. Field of the Invention

The present invention relates to a printing system, and more particularly, to a printing system capable of storing a frequently printed document in a printer and printing the stored document directly from the printer as necessary, and a method of controlling the printing system.

2. Description of the Related Art

A conventional printer receives printing data transmitted from a host, e.g., a personal computer (PC), through a network, and prints the received data on sheets of printing paper. In other words, the printer is an apparatus that includes an electronic signal processor for processing signals until the printing data received from the host PC is printed. The printer also includes a mechanism for supplying the sheets of printing paper and performing a printing operation in text or image format on the printing paper corresponding to the printing data.

The conventional printing operation operates as follows. In order to print a document by using the printer, a user searches and selects a desired document in the PC and gives a print command. For frequently printed documents or forms, it is very time-wasting to search and give a print command for each printing is desired. In order to overcome this problem, another type of conventional printing system has been developed. In this type of printing system, a user can store the printing data in a memory of the printer and print the stored data through keys provided on a panel of the printer, or print or delete the data through an application program of the PC.

In the conventional printing systems described above, when the user selects a print mode through manipulation of the keys on the panel of the printer, or through the printer application program loaded in the host PC, a brief piece of information is displayed on a monitor of the panel or of the host PC. This information includes, for example, a name of the printed document as stored in the printer, or a volume of printouts (i.e., total sheets of printouts). Then, as the user selects a certain document through the displayed information and inputs a print command, all of the pages of the selected document are printed.

In the conventional printing systems as described above, all of the pages of the selected document are always printed, even when the user needs only a part of the selected document. Accordingly, time and resources are wasted.

Furthermore, since the printing data is not recognized in an image format, but in a text format, sometimes an unwanted document is printed.

### SUMMARY OF THE INVENTION

Accordingly, it is an object of the present invention to overcome the above-mentioned problems of the related art.

It is a further object of the present invention to provide a printing system that allows a user to check and print an image of a certain part of stored printing data, and a method of controlling the same.

Additional objects and advantages of the invention will be set forth in part in the description which follows and, in part, will be obvious from the description, or may be learned by practice of the invention.

The foregoing and other objects and advantages are achieved by providing a printer including a storing portion to store printing data including pages and printing data information; a print portion to print the printing data on a sheet of printing paper; an interface to transmit/receive the printing data and the printing data information to/from an external device; a controller to transmit the printing data and the printing data information through the interface, and to control the print portion to print a selected page or pages of the printing data according to a print command, the print command being received from the external device and to request the printer to print the selected page or pages of the printing data.

The foregoing and other objects and advantages are also achieved by providing a printer control device including an input portion to input a print command to print a selected page or pages of printing data stored in a printer; an interface to transmit/receive the selected printing data and printing data information; a display to display the printing data information, and to display a setup menu to designate the selected printing data through the input portion; and a controller to display the printing data information received through the interface on the display, and to transmit the print command to the printer through the interface when the print command is input through the input portion.

The foregoing and other objects and advantages are still further achieved by providing a method of controlling a printing operation of a printer including transmitting printing data and/or printing data information stored in the printer to a printer control device; receiving the printing data and/or the printing data information transmitted from the printer at the printer control device; displaying the printing data and/or the printing data information on the printer control device; transmitting a print command to print a selected portion of the printing data from the printer control device to the printer; receiving the print command transmitted from the control device at the printer; and printing the selected portion of the printing data according to the print command at the printer.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 is a block diagram of a printing system according to the present invention;

FIG. 2 is a flowchart explaining an operation of a printer that is operated according to a command transmitted from a host PC of FIG. 1;

FIGS. 3 through 5 are views of screens on a monitor of the host PC of FIG. 1 displaying information on the printing data and screens for the user to input a print command therethrough;

FIG. 6 is a flowchart explaining an operation of the printer that is printed in accordance with a transmission request for the printing data locked by the host PC of FIG. 1;

FIG. 7 is a flowchart explaining an operation of the printer that is operated in accordance with the print command inputted through a panel of the printer of FIG. 1; and

FIG. 8 is a view of a screen displayed on an LCD for a user to input his/her selection of the number of pages when the user uses the printer panel to command printing of printing data, according to the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

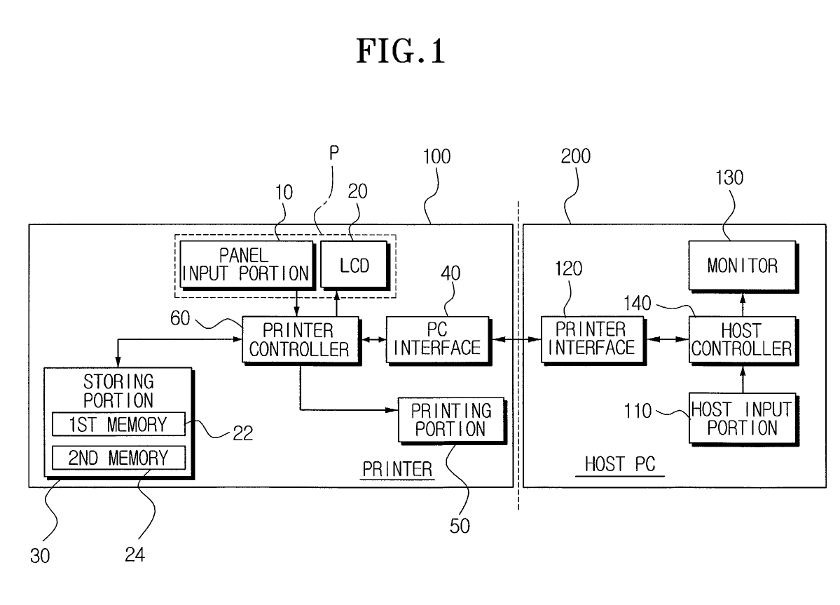

FIG. 1 is a block diagram of a printing system in accordance with an embodiment present invention. As shown in FIG. 1, the printing system includes a printer 100 to print data stored in an internal memory onto sheets of printing paper according to a print command transmitted through a panel P or from the outside, and a host PC 200 to transmit the print command to the printer 100 in response to an input of a user's selection of a certain part of the printing data stored in the printer 100. Although the host PC 200 is used herein as a printer control apparatus, the printer control apparatus may also include a Personal Digital Assistant installed with functions of the present invention, or electronic appliances connected through a mobile terminal or a home network.

The printer 100 includes the panel P including an input portion 10 and an LCD 20, a storing portion 30, a PC interface 40, a printing portion 50 and a printer controller 60.

The storing portion 30 includes a first memory 22 and a second memory 24. The printing data is stored in the first memory 22, while image data for network transmission is stored in the second memory 24. Here, the image data for network transmission is generated by reducing a size and resolution of image data of original pages of the printing data that are printed. The printing data and the image data for network transmission can be stored in a single memory.

The input portion 10 receives a user's selection of certain parts (typically pages) of the printing data and a user's print command. The LCD 20 indicates the operational status of each component to the user, and also indicates information on the printing data and a setup screen for the selected parts of the printing data in response to a command inputted from the input portion 10. The PC interface 40 interfaces with the host PC 200 regarding the printing data and/or the information on the printing data.

The printing portion 50 prints the printing data stored in the first memory 22 onto the sheets of printing paper under the control of the printer controller 60. The printer controller 60 controls the general parts of the printer 100. Particularly, the printer controller 60 controls each block so that a certain part of the printing data can be printed in accordance with the print command transmitted through the panel P, or from the host PC 200.

Meanwhile, the host PC 200 includes a host input portion 110, a printer interface 120, a monitor 130 and a host controller 140. The host input portion 110 receives a print command from the user about the printing operation of the certain part of the printing data stored in the printer 100. A general keyboard or a mouse can serve as the host input portion 110. The printer interface 120 interfaces with the printer 100 regarding the printing data stored in the printer 100 and/or the information on the printing data. The monitor 130 indicates the information regarding the printing data transmitted through the printer interface 120 and a setup screen to designate the selected part of the printing data.

The host controller 140 collects information about the printing data from the printer 100 and displays this information on the monitor 130. The host controller 140 performs a control operation so that, when the selected part of the printing data is designated and the print command is inputted through the host input portion 110, the print command is transmitted to the printer 100, instructing the printer 100 to print the selected part of the printing data.

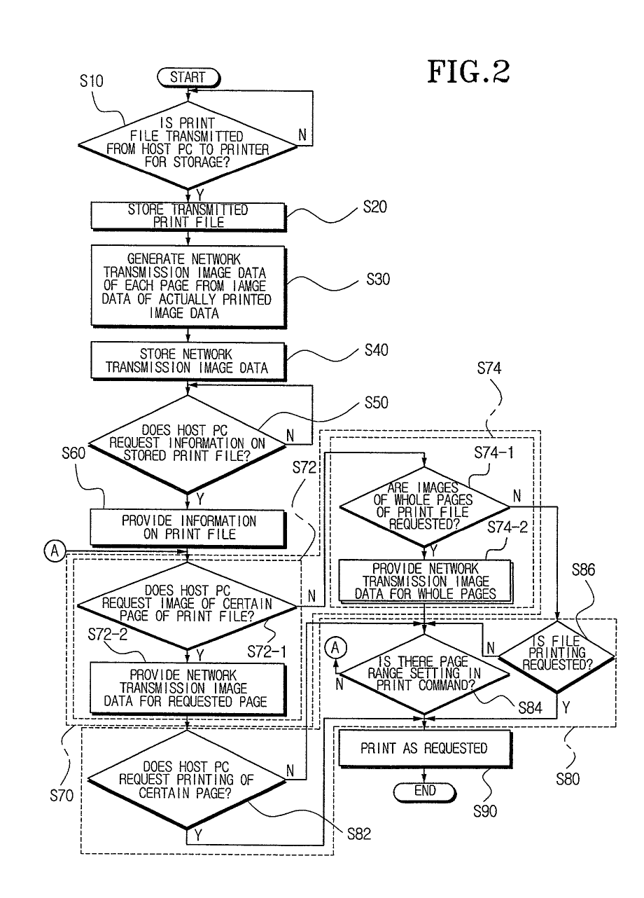

Operations of the printer 100 and the host PC 200 with respect to each other will be described with reference to the flowchart and views of FIGS. 2 and 3, 4 and 5.

First, the printing data to be stored in the printer 100 is transmitted from the host PC 200 to the printer 100 (operation S10). Next, the printer controller 60 stores the transmitted data in the first memory 22 (operation S20) and generates separate network transmission image data from image data of the original pages that are to be printed (operation S30). Then, the generated image data is stored in the second memory 24 (operation S40). The image data is generated for a fast transmission in the network in response to a request from the host PC 200 for printing data stored in the printer 100. For a more convenient explanation, the image data will be called ‘network transmission image data’ hereinafter.

The network transmission image data is generated at the printer controller 60 by varying the resolution and size of the image data of the respective pages of the printing data that are printed. For example, for a page of 600 dpi of a full letter size, the network transmission image data is generated to be 72 dpi of a quarter letter size. Meanwhile, if the printing data is in bitmap format, the network transmission image data need not be stored. Instead, upon a request by the image data transmission request from the host PC 200, the network transmission image data can be generated at the printer controller 60 based on the printing data stored in the first memory 22 and transmitted to the host PC 200. Furthermore, for easier processing, the network transmission image data can be converted from a simple bitmap format to another format such as ‘jpeg’, which is more easily processed at the host PC 200.

When there is a signal transmission from the host PC 200 to the printer 100 requesting information about the printing data (operation S50), the printer controller 60 of the printer 100, that has generated and stored the network transmission image data, provides the host PC 200 with the information about the printing data that is stored in the first memory 22 (operation S60). The information as provided includes the user name of the printing data, file name, file volume, total pages and link data about network transmission image data linked to each page.

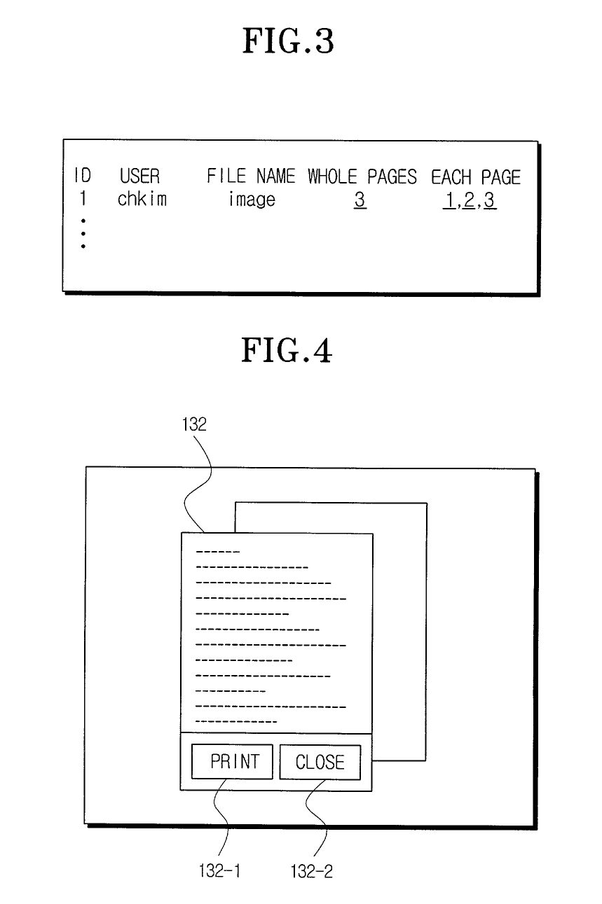

When the information about the printing data is transmitted from the printer 100 to the host PC 200, the host controller 140 displays a screen as shown in FIG. 3 on the monitor 130 based on the information on the transmitted printing data. When the user selects one of the numbers ‘1’, ‘2’ and ‘3’, which are linked to the network transmission image data of the printed page of the printing data stored in the second memory 24, the host controller 140 transmits a signal to the printer 100, requesting image information about the selected page. Accordingly, when the signal is transmitted from the host PC 200 through the link data, requesting the image data of the specific page (sub-operation SS72-1), the printer controller 60 provides the host PC 200 with the network transmission image data of the selected page that is stored in the second memory 24 (sub-operation SS72-2).

When the network transmission image data is provided from the printer 100, under the control of the host controller 140, the image of the selected page is displayed on a new window 132 of FIG. 4. In the window 132 displaying the image of the network transmission image data, a print button 132-1 and a close button 132-2 are displayed at the bottom. Through the print button 132-1, the user gives a command to the printer 100 to print the selected page. The close button 132-2 is to close the window 132. Accordingly, when the print button 132-1 is selected, the host controller 140 transmits a signal to the printer 100, requesting the image displayed on the monitor 130 to be printed. Upon receipt of the print command about the certain page from the host PC 200 (operation S82), the page corresponding to the printing data stored in the first memory 22 is printed through the printing portion 50 under the control of the printer controller 60 (operation S90).

Meanwhile, FIG. 3 shows the display of the information on the printing data stored in the first memory 22 that is provided to the host PC 200. Here, as the user selects all of the pages (i.e., number ‘3’) with his/her mouse, the host controller 140 transmits to the printer 100 a signal that requests images of all of the pages of the printing data. When the request signal for the image of all of the pages of the printing data is transmitted (sub-operation SS74-1), the print controller 60 transmits to the host PC 200 the network transmission image data about all of the pages of the printed data as requested (sub-operation SS74-2) (operation S74).

Also, when the print request for all of the pages is transmitted to the printer 100 without the request for the transmission of the image data of the printing data from the host PC 200 (operation S86), the printer controller 60 prints all of the pages of the corresponding printing data stored in the first memory 22 (operation S90).

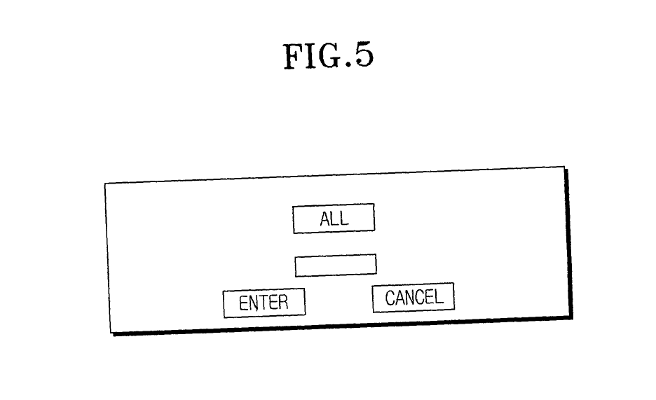

Furthermore, when the user wants to print a certain range of the printing data through the host input portion 110, a window for print range setup is displayed, as shown in FIG. 5. The window displays an ‘ALL’ button to select all of the pages and a page setting space for the user to input his/her desired number of pages. The user may select the number of pages, for example, by inputting numbers such as ‘1’, ‘3’ and ‘5’ in the page setting space. The user also may select the range of his/her desired pages, such as ‘1-3’, or the like. FIG. 5 further illustrates ‘enter’ and ‘cancel’ buttons. The host controller 140 transmits to the printer 100 the print command in accordance with the user's set pages. As the print range is determined and the corresponding print command is transmitted to the printer 100 from the host PC 200 (operation S84), the printer controller 60 prints the selected range of the pages of the printing data stored in the first memory 22 through the printing portion 50 (operation S90).

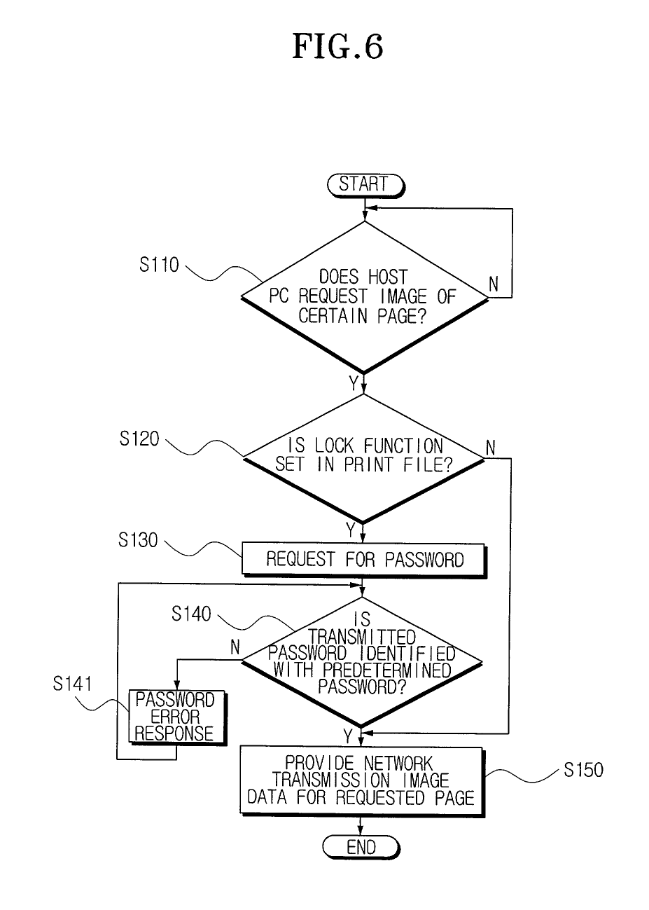

Furthermore, as shown in FIG. 6, upon receipt of the requesting signal for the information on the image information of the printing data from the host PC 200 (operation S110), the printer controller 60 determines whether a lock function is set for the selected printing data (operation S120). When it is determined that the lock function is set, the host PC 200 requests a password (operation S130). When the password is transmitted from the host PC 200, the transmitted password is compared with a pre-determined password (operation S140). When the password is identified with the pre-determined password, the network transmission image data for the requested page is transmitted to the host PC 200 (operation SI 50). If the password is not identified as the pre-determined password, a response is transmitted to the host PC 200 indicating there is an error in the password (operation S141).

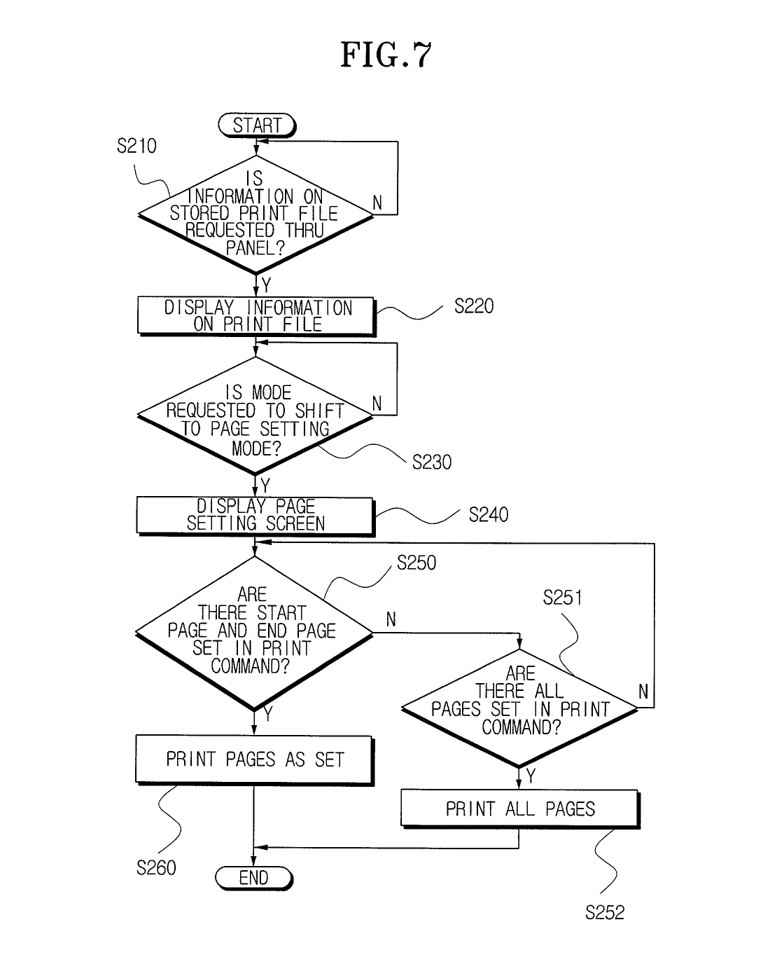

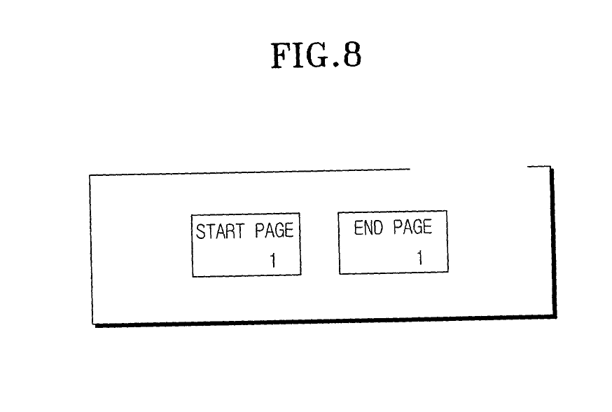

Meanwhile, the printer 100 may give a print command through the panel input portion 10. As shown in FIG. 7, when the print mode is selected through the panel input portion 10, requesting the information on the printing data (operation S210), the print controller 60 displays the information about the printing data stored in the first memory 22 in the LCD (operation S220). Then, when the user inputs a command to shift the mode to the page setting mode through the panel input portion 10 (operation S230), the page setting window (as shown in FIG. 8) is displayed in the LCD 20 (operation S240). After setting the start page and end page in the page setting mode, the user re-inputs a print command (operation S250). Then the selected range of the pages of the printing data in the first memory 22 is printed through the printing portion 50 under the control of the printer controller 60 (operation S260). In the case when the page setting space indicates ‘ALL’ as the page number items, the user may give a print command to print the entire document. Accordingly, when the user selects the ‘ALL’ item in the page setting space (operation S251), the printer controller 60 prints all of the pages of the printing data through the printing portion 50 (operation S252).

In the above-mentioned printing system in accordance with the present invention, since the user is able to print his/her desired number of pages of the printing data stored in the printer 100, unnecessary waste of resources can be prevented. Furthermore, since the user can view in advance the image of the respective pages of the stored printing data to be actually printed, there is a lower possibility of print error. Still further, since the network transmission image data, which is smaller in size than the printed data, is transmitted instead of the printed data, an image check before printing can be achieved very quickly.

Even further, since the image checking and file printing can be achieved through the password certification, the security of important printing data can be guaranteed.

Although a few preferred embodiments of the present invention have been shown and described, it will be appreciated by those skilled in the art that changes may be made in these embodiments without departing from the principles and spirit of the invention, the scope of which is defined in the claims and their equivalents.

What is claimed is:

1. A printer, comprising:
a storing portion to store printing data and printing data information;
a print portion to print the printing data on a sheet of printing paper;
an interface to transmit/receive the printing data and the printing data information to/from an external device; and
a controller to transmit the printing data and the printing data information through the interface, to control the print portion to print a selected portion of the printing data according to a print command, the print command being received from the external device, and to request the printer to print the selected portion of the printing data.

2. The printer of claim 1, wherein the controller generates image data corresponding to the selected portion of the printing data by converting a size and/or a resolution of the selected portion of the printing data, the image data including the printing data information and the controller stores the printing data information in the storing portion.

3. The printer of claim 2, wherein the controller converts the image data to a format to be used by the external device.

4. The printer of claim 2, wherein the controller transmits the image data corresponding to the selected portion of the printing data in response to a request to transmit the selected portion, the request being transmitted from the external device.

5. The printer of claim 4, wherein the controller transmits the image data after certifying the printing data.

6. The printer of claim 1, further comprising:
an input portion to input the print command to print the selected portion; and
a display to display the printing data information, and to display a setup menu to designate the selected portion through the input portion,
wherein the controller controls the print portion to print the selected portion when the print command to print the selected portion is input through the input portion.

7. A printer control device, comprising:
an input portion to input a print command to print a selected portion of printing data stored in a printer;
an interface to transmit/receive the selected printing data and printing data information;
a display to display the printing data information, and to display a setup menu to designate the selected printing data through the input portion; and
a controller to display the printing data information received through the interface on the display, and to transmit the print command to the printer through the interface when the print command is input through the input portion.

8. The printer control device of claim 7, wherein the controller generates image data corresponding to the selected printing data by converting a size and/or a resolution of the selected printing data at the printer, and the printing data information displayed on the display includes hypertexts linked to the image data.

9. The printer control device of claim 8, wherein, when one of the hypertexts of the selected printing data displayed on the display is selected, the controller receives the image data corresponding to the selected printing data linked to the hypertext of the selected printing data from the printer, and displays the image data of the selected printing data on the display.

10. The printer control device of claim 9, wherein the controller displays the image data of the selected printing data on a new window of the display.

11. The printer control device of claim 10, wherein a button to input the print command is provided on the new window.

12. The printer control device of claim 8, wherein the controller displays a password input window to input a password when the printer requests a password, and transmits the password to the printer when the password is input through the input portion.

13. The printer control device of claim 7, wherein the controller displays a printing range setup window to designate a start page and an end page of the selected printing data, when the selected printing data is selected through information input to the setup window.

14. A method of controlling a printing operation of a printer, comprising:
transmitting printing data and/or printing data information stored in the printer to a printer control device;
receiving the printing data and/or the printing data information transmitted from the printer at the printer control device;
displaying the printing data and/or the printing data information on the printer control device;
transmitting a print command to print a selected portion of the printing data from the printer control device to the printer;
receiving the print command transmitted from the printer control device at the printer; and
printing the selected portion of the printing data according to the print command at the printer.

15. The method of controlling the printing operation of the printer of claim 14, further comprising:
requesting transmission of the printing data information from the printer control device to the printer before transmitting the printing data and/or the printing data information to the printer control device.
